(19) United States
(12) Patent Application Publication
(10) Pub. No.: US 2009/0062051 A1
(43) Pub. Date: Mar. 5, 2009

(54) Silent chain transmission device

(75) Inventors: Toshitaka Ogo, Osaka (JP); Kenichi Nagao, Osaka (JP); Shouta Miyanaga, Osaka (JP); Tomonori Yoshimura, Osaka (JP); Toyonaga Saitoh, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/999,312

(22) Filed: Dec. 5, 2007

(30) Foreign Application Priority Data
Aug. 29, 2007 (JP) 2007-222947

(51) Int. Cl. F16G 13/04

(52) U.S. Cl. 474/213

(57) ABSTRACT

In a silent chain, a link plate is formed by punching, followed by simultaneous shearing of the inner surfaces of the pin holes, the inner engagement surfaces of the teeth, the outer engagement surfaces of the teeth, the connecting arc continuous with the inner connecting surfaces, and the back of the link plate over at least 70% of the plate thickness. The plates are arranged at random to form a link, and engage a sprocket first by engagement of an inner engagement surface with a sprocket tooth, and thereafter seat on the sprocket with outer engagement surfaces of the link teeth in engagement with the sprocket teeth.

### CROSS-REFERENCE TO RELATED APPLICATION

This application claims priority on the basis of Japanese application 2007-222947, filed Aug. 29, 2007. The disclosure of Japanese application 2007-222947 is hereby incorporated by reference.

### FIELD OF THE INVENTION

This invention relates to a silent chain for use as a timing chain in an automobile, or a power transmitting chain in an industrial machine or the like.

### BACKGROUND OF THE INVENTION

A silent chain used in an engine or the like comprises interleaved widthwise rows of toothed link plates, articulably connected by connecting pins which extend through pin holes in the link plates. As a link plate approaches a sprocket, an inner engagement surface of an inner flank of the link plate first engages a sprocket tooth. Thereafter, an outer engagement surface of an outer flank of the link plate becomes seated on the sprocket to transmit power.

The link plates are manufactured by moving a blank composed of steel sheet past sets of punches, which form pin holes in a pressing step, and punch an outline of a plate in another pressing step, the outline comprising inner engagement surfaces, outer engagement surfaces and a back surface. The pin holes of a link plate can be formed either before or after the formation of the outline of the plate. The formation of a link plate is described in Japanese Laid-Open Patent Publication No. 2005-22107.

In the conventional silent chain, low noise and wear resistance can realized by improving the punching accuracy and the dimensional accuracy of the link plate. However, low noise and wear resistance are difficult to achieve without these measures. For example, even if, in a conventional silent chain, a link plate 511 as shown in FIG. 10(a) is accurately punched out, the positions of the inner surfaces 511a of the punched holes can be slightly shifted relative to the outline of the link plate due to causes such as vibration during punching. Consequently, the distances A and B from the holes to the adjacent outer flanks of the link plate can differ, as can the distances C and D from the centers of the holes to a center line of the link plate. As shown in FIG. 10(a), A>B and C<D. The height h of the centers of the holes, measured from a point defined by intersections of extensions of the straight parts of the outer flanks of the plate can also vary. Since the punched pin holes in the link plate are not always symmetrical with respect to the outline of the link plate as shown in FIG. 10(c), where A=B and C=D, and since the heights h can vary, when a number of randomly arranged link plates 511 are disposed in parallel to one other in the chain width direction and their pin holes are aligned in the process of chain assembly, the overall outer shape of a link row 510, defined by W and H, which are based on projections of the link plates in the row, is will become slightly larger than the outer shape of an individual link plate 511, as shown in FIG. 10(b).

The slight increase in the overall size of a link row due to the differences between its link plates causes a problem in that the engagement between the chain and a sprocket becomes excessively tight by amounts δw and δh, as shown in FIG. 10(b), which are the amounts by which the overall link row dimensions W and H are larger than dimensions w and h of each individual plate. These differences can result in vibrations, noise, a remarkable reduction in wear resistance, and even engagement failure.

Furthermore, when the link plates of the conventional silent chain engage with a sprocket and seat thereon, a polygonal motion of the chain is generated. Thus, there was a problem in that significant vibration, noise, and changes in tension of the silent chain, could not be avoided.

There were also problems in that the portion of the link plate that connects its two inner flanks can interfere with a tooth head of a sprocket, and the a tooth head of a V-shaped link tooth can interfere with a tooth gap bottom of a sprocket, causing wear loss such as partial wear, tooth chipping, and the like in a connecting portion of a link plate, a tooth head of a link tooth, and a tooth gap bottom on the sprocket.

An object of the invention is to solve the above-mentioned problems encountered in conventional silent chains, and to provide a silent chain that can be easily produced, in which stable engagement, excellent lateral balance in the chain width direction, low noise, and low vibration can be realized, and in which fatigue fracture of the link plates and wear elongation of the chain are suppressed, even though the plates in a link row of the chain are selected and arranged at random.

### SUMMARY OF THE INVENTION

A silent chain transmission according to the invention comprises a silent chain and a sprocket. Interleaved link rows of the chain, each comprising a plurality of randomly arranged link plates, are disposed in parallel relationship to one another. The rows extend in a chain width direction, and are connected by connecting pins extending through pin holes of the link plates. The link plates have teeth with inner and outer engagement surfaces shaped so that, at the beginning of engagement with the sprocket, an inner engagement surface begins to engage a sprocket tooth, and, after a link plate begins to engage with a sprocket, an outer engagement surface of the link plate seats on the sprocket. In each link plate, an inner engagement surface that begins to engage a sprocket tooth, the inner surfaces of its pin holes, and the outer engagement surface that seats on a sprocket tooth are punched by pressing, and each includes a shear surface. The shear surfaces of each plate are formed simultaneously by shaving, after pressing, and extend over a range of at least 70% of the plate thickness.

The width w of each plate in a link row, and the height h of each said plate are preferably smaller than the width W and height H of a link, defined as the height and width of envelope of the plates of the same link row link projected in the chain width direction, and the width W and height H are preferably substantially equal to a design width Ws, and design height Hs for proper engagement with the sprocket.

Preferably, the inner engagement surface of each link plate has the same shape as the tooth form, in cross section, defined in a hob axis direction, of a hob cutter shaped to form the teeth of the sprocket.

Each plate includes a curved surface continuous with opposed inner engagement surfaces of the teeth. The curved surface preferably includes a shear surface formed by punching in a press, and shaved after pressing over a range of at least 70% of the plate thickness.

In each link plate, The right angle relationship between the faces of the plates and the inner engagement surfaces, the inner surfaces of the pin holes and the outer engagement surfaces, is improved. Parallelism of the engagement surfaces and the inner surfaces of the pin holes surface accuracy are improved. The inner surfaces of the pinholes and the connecting pins come into contact with each other in parallel, the mutual contact area is increased, and concentrated loads are avoided. Thus, wear is reduced and chain wear elongation can be suppressed. Additionally, since the distance accuracy of the inner engagement surfaces and the outer engagement surfaces with respect to the inner surfaces of the pin holes is improved, stable engagement with a sprocket tooth surface can be attained.

Since a plurality of shaved link plates are arranged in parallel in a chain width direction at random, shear surfaces and unsheared surfaces (fracture cross-sections) of the respective link plates are arranged at random in the chain width direction of a link row. Since the right angle relationship between the faces of the plates and the inner engagement surfaces, the inner surfaces of the pin holes and the outer engagement surfaces, is improved, and the parallelism and surface accuracy of these surface are improved without being influenced by the punching direction for shaving, uniform and stable engagement with a sprocket tooth surface can be attained. Moreover, excellent lateral balance in the chain width direction can be exhibited by a random arrangement of the link plates.

Where The width w of each plate in a link row, and the height h of each said plate are smaller than the width W and height H of a link, and the width W and height H are substantially equal to a design width Ws, and design height Hs for proper engagement with the sprocket, the link row of the silent chain reliably engages with the sprocket, and accurately travels around the sprocket on a travel line so that low noise and low vibration can be realized. Even if the link plates are laterally asymmetric during assembly of the chain, since the link rows can be easily arranged and assembled in parallel without considering the punching and shaving direction, excellent lateral balance in the chain width direction is exhibited, the difficulty of chain assembly is reduced and its manufacturing accuracy is increased, so that productivity is remarkably improved.

Where inner engagement surfaces of the link plate have the same shape as the tooth form, in axial cross-section, of a hob cutter which forms the sprocket teeth, the inner engagement surfaces of the link plates, which sequentially travel toward the sprocket in a straight tangential direction, are received by the sprocket teeth without departing from the chain travel line on the sprocket, so that stable, smooth engagement is started, and a gentle shift from inner engagement to outer engagement occurs while sufficient engagement time on the inner engagement surfaces is ensured. Thus, noise due to travel vibration of the silent chain wrapped around the sprocket is reduced, and, at the same time, impact noise due to impact between the chain and the sprocket is reduced.

Where the bent surface which is continuous with the opposed inner engagement surfaces of a link plate includes a shear surface shaved after pressing of the link plate, and the shear surface extends over a range of 70% or more of the plate thickness, fine surface cracks, which are liable to be generated in the bent surface of a conventional link plate, are avoided, and fatigue fracture of the link plate is prevented. Thus, excellent chain durability can be exhibited.

### BRIEF DESCRIPTION OF THE DRAWINGS

FIG. 1 is a perspective view showing a part of an outer a silent chain according to the invention;

FIG. 2 is an enlarged schematic view of a link plate of the silent chain of FIG. 1;

FIG. 3 is an enlarged cross-sectional view taken on plane III-III in FIG. 2;

FIG. 4(a) is an enlarged cross-sectional view of a part of a silent chain according to the invention;

FIG. 4(b) is an enlarged cross-sectional view of a part of a conventional silent chain;

FIG. 5(a) is a schematic view showing the dimensions of a link plate according to the invention;

FIG. 5(b) is a schematic view showing the dimensions of a link row according to the invention;

FIG. 6(a) is a schematic view illustrating the engagement of the silent chain according to the invention with a sprocket;

FIG. 6(b) is a schematic view illustrating the engagement of a conventional silent chain with a sprocket;

FIG. 7(a) is an enlarged schematic view showing details of the engagement of a silent chain according to the invention with a sprocket;

FIG. 7(b) is an enlarged schematic view showing details of the engagement of a conventional silent chain with a sprocket;

FIG. 8 is a schematic view showing thee relationship between the teeth of the silent chain of the invention and a hob cutter used to form a sprocket for use with the chain;

FIG. 9 is an enlarged view illustrating the engagement of the silent chain shown in FIG. 1 with a sprocket; and

FIG. 10 is a view showing the relationships between the shape of a plate and the shape of a link in a conventional silent chain.

### DETAILED DESCRIPTION OF THE PREFERRED EMBODIMENTS

The silent chain transmission according to the invention comprises a silent chain and a sprocket. Each of the interleaved link rows of the chain comprise a plurality of randomly arranged link plates, disposed in parallel relationship to one another, the rows extending a chain width direction, and connected by connecting pins extending through pin holes of the link plates. The link plates have teeth with inner and outer engagement surfaces shaped so that, at the beginning of engagement with the sprocket, an inner engagement surface begins to engage a sprocket tooth, and, after a link plate begins to engage with a sprocket, an outer engagement surface of the link plate seats on the sprocket. In each link plate, an inner engagement surface that begins to engage a sprocket tooth, the inner surfaces of its pin holes and the outer engagement surface that seats on a sprocket tooth, are punched by pressing, and each said surface includes a shear surface, the shear surfaces of each link plate being simultaneously formed by shaving after pressing, and extending through a range of at least 70% of the plate thickness.

In such a chain, stable engagement, excellent lateral balance in the chain width direction, low noise and low vibration, are realized even with a random arrangement of link plates. Fatigue fracture of the link plates and wear elongation of the chain are suppressed. The cost and difficulty of chain assembly are reduced, and manufacturing accuracy is improved.

The connecting pins used in the silent chain of the invention can be of various kinds, including round pins having a circular cross-section, or a rocker pins, each composed of a short pin and a long pin. Where a round pin is used, it is liable to come into contact with the inner surfaces of two or more pin holes in link plates parallel to one other, and the contact surface area is increased and, accordingly, wear is decreased so that chain wear elongation can be suppressed.

Shaving of the link plate in accordance with the invention is carried out by a process similar to punching, except that a portion of a blank material is shaved by means of a bar-shaped or column-shaped shaving tool having a slightly larger contour than that of the edge of the punched portion formed by the preceding step of punching the blank material by means of a punch. Accordingly, with a punch so that the contour of the edge formed in the punching step is slightly shaved to remove surface roughness and sagging generated in the punching step. Accordingly, the surface roughness of the punched portion is reduced, and the surface accuracy of the punched portion are improved.

In accordance with the invention, shaving is preferably applied at least to the inner engagement surfaces of the link plate, to the inner surfaces of the pin holes and to the outer engagement surfaces of the link plate. Optionally, the back surface of the link plate can also be shaved. When the back surface is shaved, smooth sliding contact between the chain and a chain guide can be attained.

Preferably, the shapes of the inner engagement surfaces of the silent chain of the invention are the same as the shape of the axial cross-section of tooth form of a hob cutter which forms the sprocket tooth surfaces of a sprocket for use with the chain. A straight tooth form or a curved tooth form may be adopted. In a hob cutter used to form a sprocket for a chain transmission of the invention, a straight tooth form, which can form an involute tooth form in the sprocket, is preferably adopted. However, as an alternative, a special curved tooth form, according to the sprocket tooth form, can be adopted.

Further, the bent surface of the link plates which connects the inside contacting surfaces of the link plate teeth is preferably in the form of an arc for uniform dispersion of the load on the bent surface during transmission of power.

The “chain pitch” in the silent chain of the invention is the distance between the centers of a pair of connecting pins inserted into the link plates of a link row, or the distance between the centers of the pin holes in a link plate. The term “chain pitch line” refers a line connecting the centers of the connecting pins inserted into the link plate, or to a line connecting the centers of the connecting pin holes in a link plate.

The dimensions w and h, which define the size and shape of a link plate of the silent chain in the invention refer respectively to the maximum width w of the link plate in the longitudinal direction of the chain, and to the shortest distance h from the chain pitch line to a point where imaginary straight extensions of the outer engagement surfaces of the link plate intersect. The dimensions W and H, which define the size and shape of a link, refer to the maximum width W, measured along the longitudinal direction of the chain, of an imaginary lateral projection of the link row, and to the shortest distance H, measured from the chain pitch line to a point where imaginary straight extensions of the outermost engagement surfaces of the same projection of the link row intersect.

Furthermore, the “design reference dimensions, Ws and Hs, are defined in the same way as W and H, and refer to a reference size and shape for a silent chain designed to become seated on tooth surfaces of a sprocket on the chain travel line during power transmission between the silent chain and the sprocket.

In a preferred embodiment of a silent chain according to the invention, the silent chain is used a timing chain for driving camshaft sprockets for operating the air intake and exhaust valves of an automobile engine at a ratio of one rotation of each camshaft for every two rotations of the crankshaft.

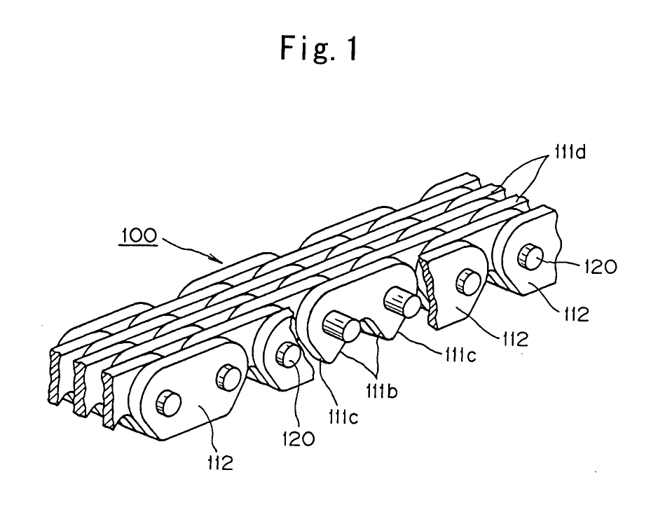

The silent chain 100, as shown in FIG. 1, is composed of interleaved link rows, each comprising a plurality of link plates disposed at random in the chain width direction. The interleaved plates are connected by round connecting pins 120 that extend through pin holes of the link plates. The link plates are shaped so that an inner engagement surface 111b of each link plate begins to engage with a sprocket, and an outer engagement surface 111c of the link plate thereafter becomes seated on the sprocket to transmit power. Every second row has guide plates 112, without teeth, disposed at its outermost ends and into which connecting pins 120 are press-fit. The connecting pins fit loosely in the holes of the toothed plates.

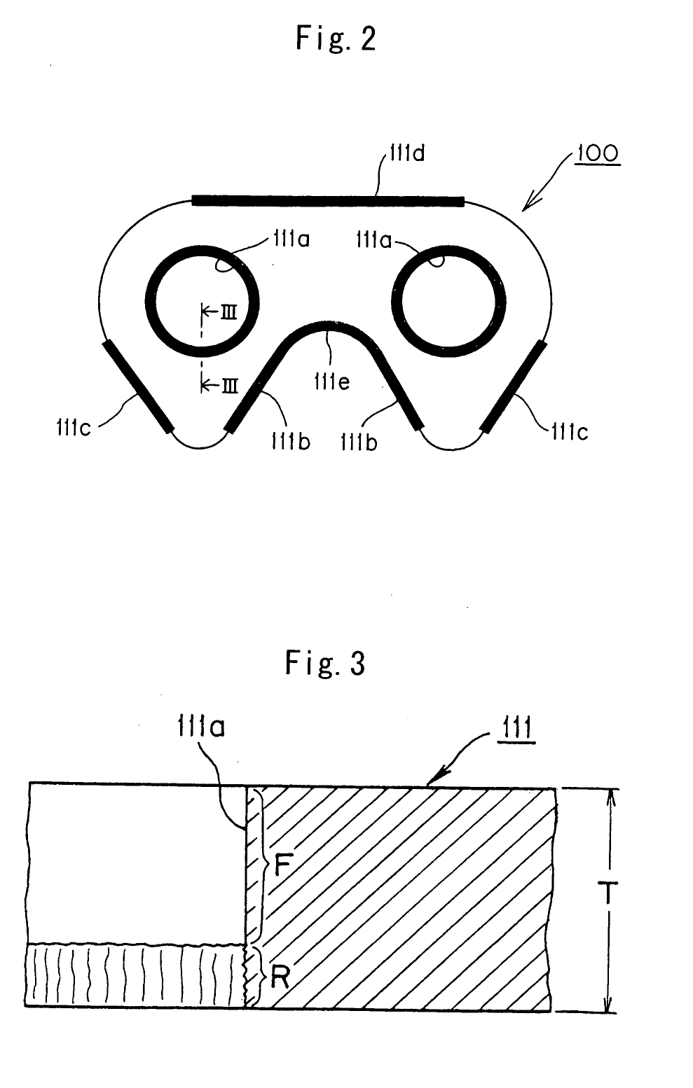

As shown in FIG. 2, the inner engagement surfaces 111b, the inner surfaces 111a of the pin holes, through which the connecting pins 120 extend, the inner engagement surfaces 111b, which face a sprocket on an inner circumferential side of the chain, the outer engagement surfaces 111c, the back surface 111d, which face away from the sprocket on the outer circumferential side of the chain, and the side bent connecting surface 111e, which is continuous with, and connects, the inner engagement surfaces 111b, are punched by pressing. These surfaces are shown by exaggerated, thick lines, and are formed simultaneously by shaving following a punching operation. Each of these surfaces is shaved over at least 70% of the plate thickness, to produce a straight shear surface. For example, the straight shaved surface F of a pin hole is shown in FIG. 3, which is a cross-section on section plane III-III in FIG. 2.

A reason why 70% or more of a plate having a thickness T is a straight shear surface F, is that practical strength of the plate is obtained and the shaving can be carried out by punching using a conventional press. The shaving of the link plate 111 is preferably carried out with a processing margin of 0.1 mm. An unshaved region R forms a fracture surface

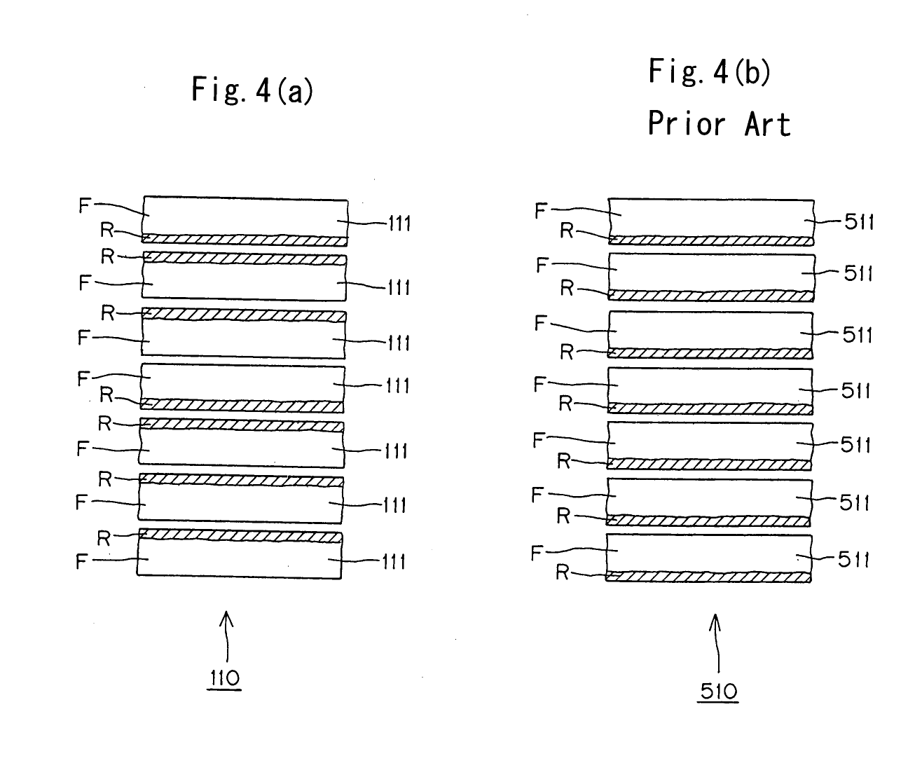

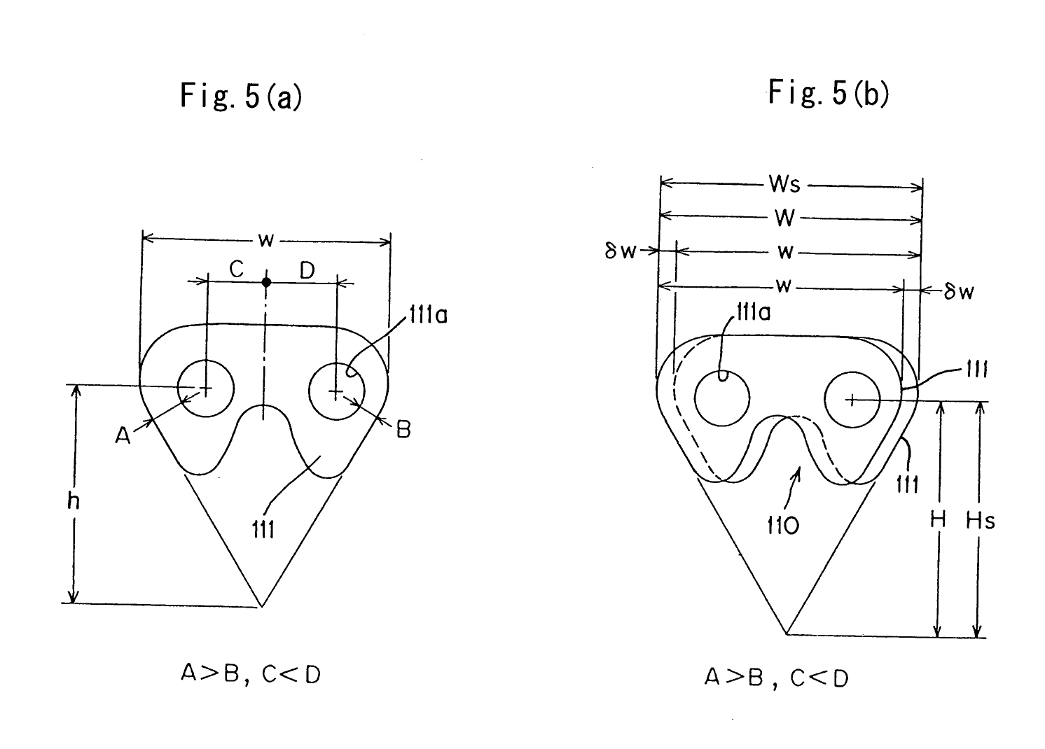

Individual link plates 111, which are used to form the silent chain 100, are punched from a blank steel sheet while setting the inner surfaces 111a of a pair of pin holes to reference positions as shown in FIG. 5(a). The interleaved link plates of the chain can be arranged regularly as in FIG. 4(b), where the shaved region F of one plate that faces an adjacent plate always faces an unshaved region R of the adjacent plate. Alternatively the plates can be arranged at random as in FIG. 4(a), where the unshaved regions F are not all on the same sides of the plates. In FIG. 4(a), where the plates are arranged at random, an unshaved region R can face a shaved region F, or an unshaved region R, of an adjacent plate. The random arrangement of FIG. 4(a) represents the invention.

The link plates 111 have a slight shift between the reference position of the inner surfaces 111a of the pin holes and the outer surfaces of the plate. For example, A>B, and C<D, as in FIG. 5(a). This shift is due to effects such as punching vibration, punching impact, or the like generated during punching of the plates. Thus, the plates become asymmetric. Moreover, these shifts have variation from one individual link plate 111 to another. As a result, the dimensions w and h of any given link plate 111 are smaller than the dimensions W and H for a link row composed of plural plates 111.

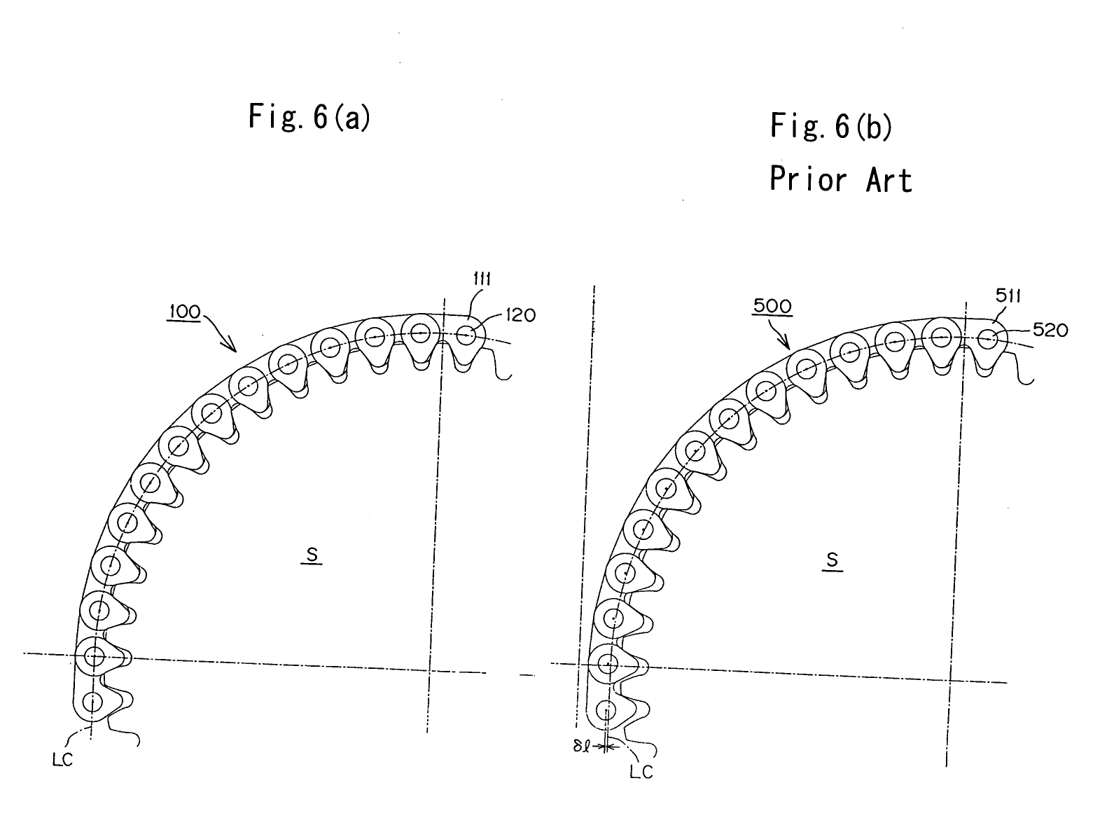

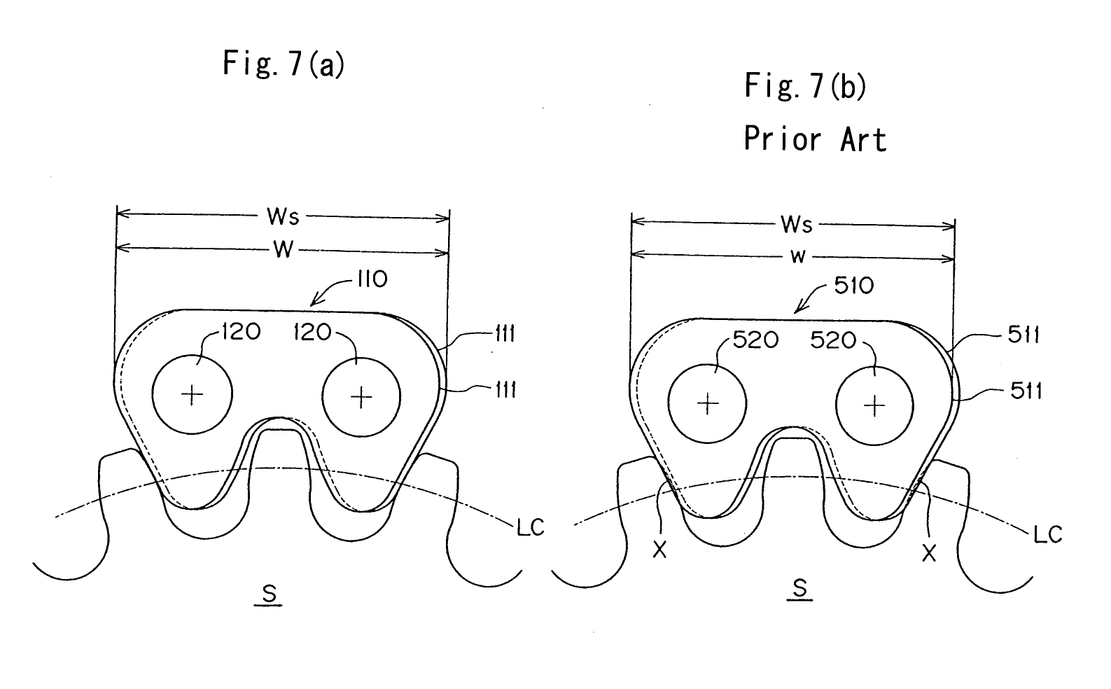

The dimensions W and H of each link composed of plural link plates 111 correspond respectively to reference dimensions Ws and Hs for properly engaging a sprocket. That is W=Ws, and H=Hs, as shown in FIG. 5(b). When W and H are respectively equal to the reference dimensions Ws and Hs, the link plate 111 engages with, and seats on, a sprocket S on a travel line Lc of the chain during power transmission, as shown in FIGS. 6(a) and 7(a).

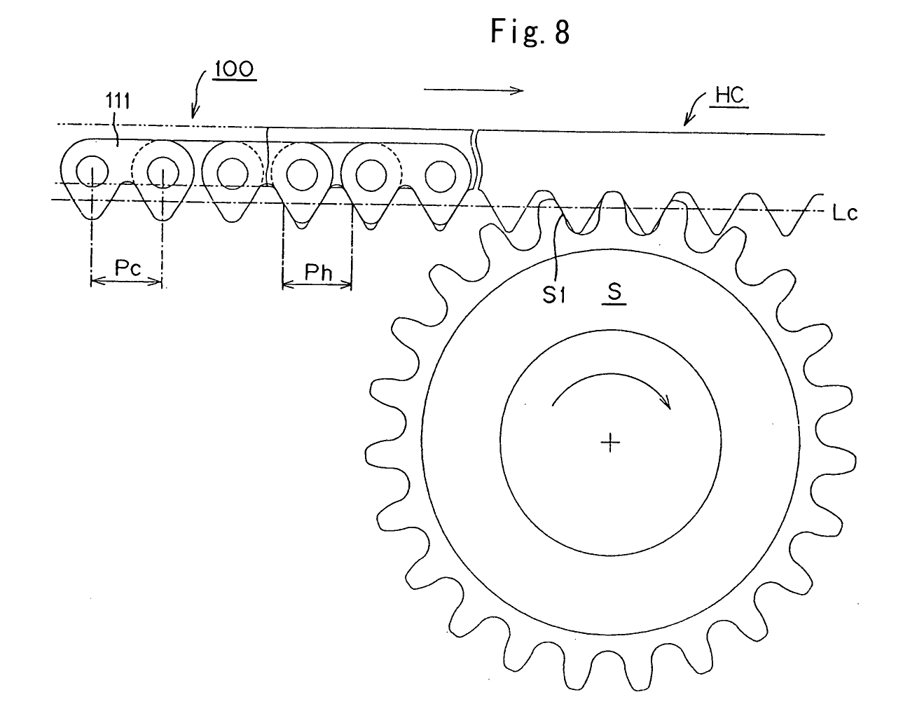

The form of the inner engagement surfaces 111b (FIG. 2) of link plate 111 are the same as the tooth form, in axial cross-section of a hob cutter HC, which forms the teeth of sprocket S as shown in FIG. 8. That is, as shown in FIG. 8, the chain pitch Pc in chain 100 is set to equal the hob pitch Ph of the hob cutter which forms the sprocket teeth S1.

As mentioned previously, the “chain pitch” Pc in the silent chain is the distance between the centers of a pair of connecting pins inserted into the link plates of a link row, or the distance between the centers of the pin holes in a link plate.

In a silent chain 100, the dimensions w and h of any link plate 111 in a link row are smaller than the dimensions W, H of the link itself. That is w<W and h<H. The dimensions W and H of link are consistent with the design reference dimensions Ws and Hs, for proper engagement with a sprocket. That is W=Ws and H=Hs. Thus, as shown in FIG. 6(a), the silent chain 100 correctly travels on a chain travel line Lc around sprocket S, such as a crankshaft sprocket or the like. At the same time, the silent chain 100 reliably engages with a sprocket tooth surface as shown in FIG. 7(a).

In a camshaft sprocket having a large number of teeth, around which a large number of link plates 111 is wrapped, and even in the case of a balancer sprocket having a large wrapping angle, the involute teeth formed by a hob cutter have the same pitch as the chain pitch. Since the link is defined by the dimensions size W and H, which consistent with the design reference dimensions Ws and Hs for proper engagement with the sprocket, no traveling occurs as shown in FIG. 6(b), where the effects of tight engagement of a conventional silent chain 500 with a sprocket S accumulate so that the chain departs from the original chain pitch line Lc by an amount 61. As shown in FIG. 7(b), engagement failure with the sprocket tooth, or excess engagement interference X can occur.

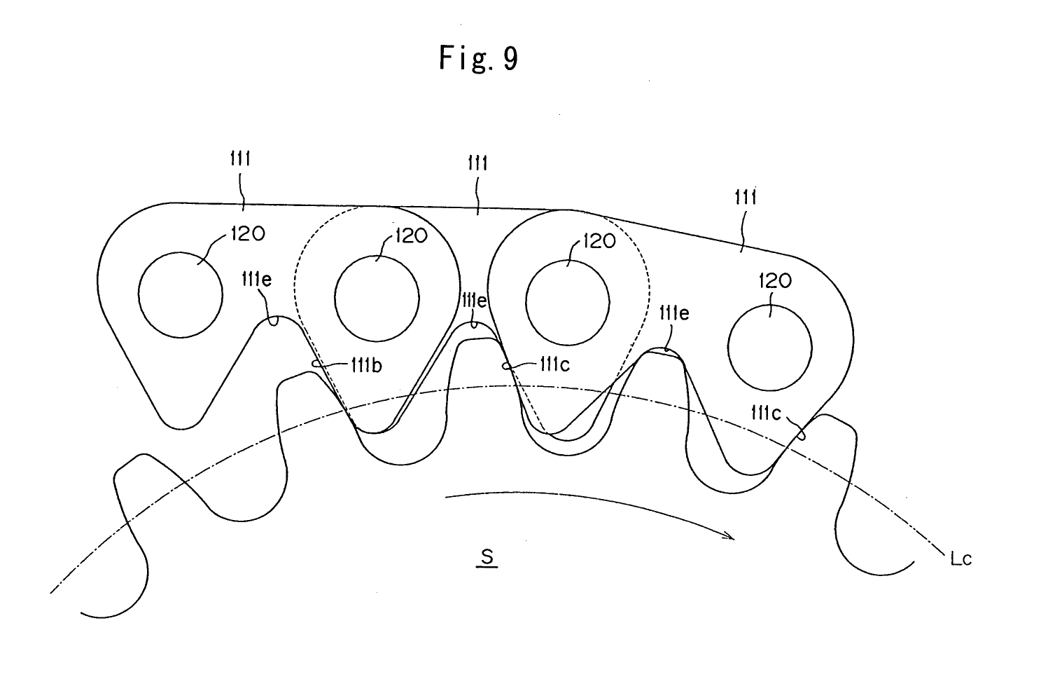

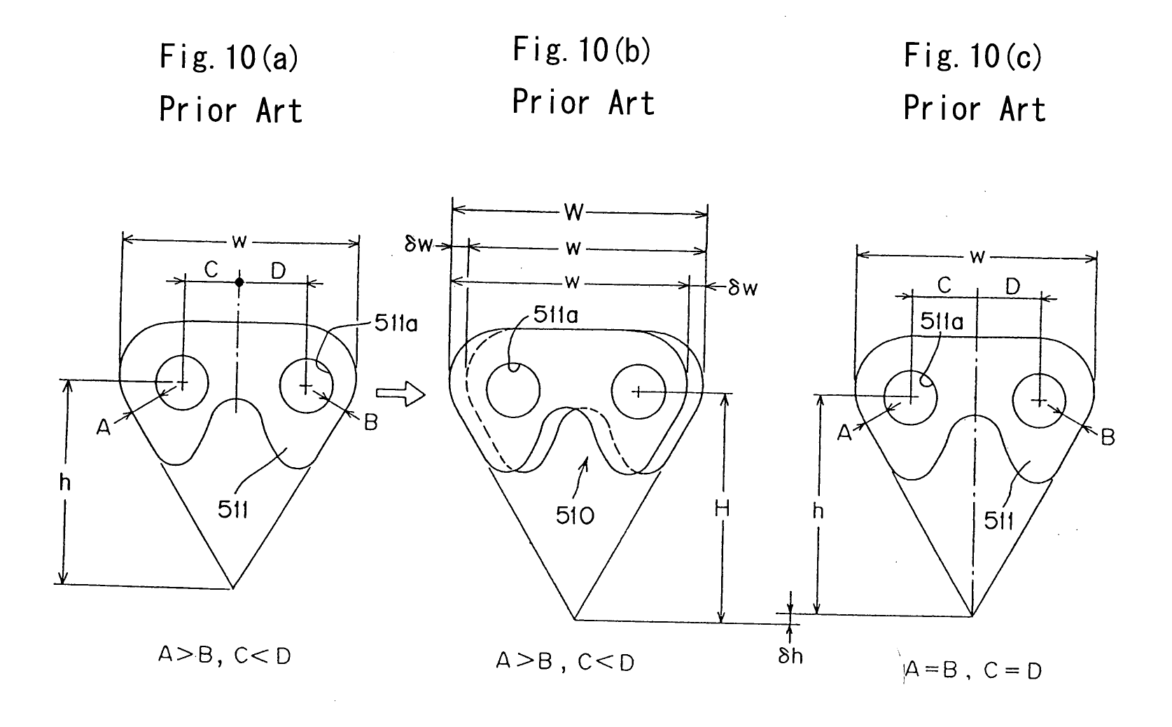

Therefore, as compared with the engagement motion in the case of a sprocket S and a conventional silent chain 500, in the silent chain 100 according to the invention, link rows in which a plurality of link plates 111 are randomly arranged in parallel to one other in the chain width direction, and are connected to one other in an interleaved arrangement by connecting pins 120 as shown in FIG. 9. The inner engagement surfaces 111b of link plates 111, which sequentially travel to the sprocket S in a straight tangential direction, are received by the sprocket teeth without moving radially with respect to the chain travel line Lc on the sprocket S. A stable, smooth, engagement is started, and a gentle shift from an inner engagement to an outer engagement takes place while ensuring sufficient engagement time between an inner engagement surface 111b and the sprocket until the silent chain 100 becomes seated on the sprocket with its outer engagement surfaces 111c engaging with sprocket teeth.

In the silent chain 100 of the invention, the inner surfaces 111a of the pin holes, the inner engagement surfaces 111b, the outer engagement surfaces 111c, the back surfaces 111d, and the bent surfaces 111e, which are continuous with two opposed inner engagement surfaces 111b are punched by pressing, and shear surfaces F are simultaneously formed by shaving after the pressing step over a range of 70% or more of the plate thickness. The right angle relationship between the shaved surfaces and the sides of the plates is improved and, at the same time, the parallelism and surface accuracy of these surface are improved. Thus, the inner surface 111a of a pin hole and a connecting pin 120 come into contact with each other in a parallel relationship, their mutual contacting surface area is increased, and no concentrated load is applied to the pin hole. Thus, wear is reduced, and chain wear elongation can be suppressed. Additionally, the accuracy of the relationship of the inner engagement surfaces 111b and the outer engagement surfaces 111c to the inner surfaces 111a of the pin holes is improved. Consequently, stable engagement with a sprocket tooth surface S1 can be attained.

Since a plurality of shaved link plates are arranged at random, in parallel, in the chain width direction as shown in FIG. 4(a), the shear surfaces F and fracture cross-sections R of the respective link plates obtained by shaving are arranged at random in the chain width direction. The right angle relationship of the inner engagement surfaces 111b, the inner surfaces 111a of the pin holes and the outer engagement surfaces 111c with respect to the flat surfaces of the link plates are improved, and the parallelism and flat surface accuracy of these surfaces are improved, and are not influenced by the punching direction. Consequently, uniform and stable engagement of the chain with a sprocket tooth surface S1 can be attained, and excellent lateral balance in the chain width direction is exhibited.

In the silent chain 100 of the invention, the dimensions w and h of a link plate, using the inner surfaces of its pin holes as a reference, are smaller, respectively, than the dimensions W and H of a link composed of plural such link plates. Moreover, the dimensions W and H of the link correspond to the design reference dimensions Ws and Hs for properly engaging a sprocket S. Consequently, the link row 110 of the silent chain reliably engages the sprocket S, and the silent chain 100 accurately travels on the travel line of the chain around the sprocket S, so that engagement with low noise and low vibration can be realized. Even if the link plates 111 are laterally asymmetric during assembly of the chain, since the link rows can be easily arranged and assembled in parallel to one another without considering the surface and back sides of the link plates 111, the difficulty of chain assembly is reduced while its manufacturing accuracy is increased, so that the productivity can be remarkably improved.

Moreover, since the inner engagement surfaces 111b of the link plate 111 have the same shape as the tooth form, in axial cross-section, of a hob cutter HC which forms the sprocket teeth S1, the inner engagement surfaces 111b of the link plates 111, which sequentially travel to the sprocket S in a straight tangential direction, and are received by the sprocket teeth without departing from the chain travel line on the sprocket, so that a stable, smooth engagement is started and a gentle shift from inner engagement to outer engagement occurs while sufficient engagement time of the inner engagement surfaces 111b is ensured. Thus, noise due to travel vibration of the silent chain wrapped around the sprocket S is reduced, and, at the same time, impact noise due to impact between the chain and the sprocket S is reduced.

Furthermore, since the bent surface 111e, which is continuous with the opposed inner engagement surfaces 111b of a link plate 111, includes a shear surface F shaved after pressing of the link plate and the shear surface extends over a range of 70% ormore of the plate thickness, fine surface cracks, which are liable to be generated in bent surface of a conventional link plate, are avoided, and fatigue fracture of the link plate is prevented. Thus excellent chain durability is exhibited.

What is claimed is:

1. A silent chain transmission comprising a silent chain and a sprocket, in which interleaved link rows of the chain, each comprising a plurality of randomly arranged link plates, are disposed in parallel relationship to one another, the rows extending a chain width direction, and connected by connecting pins extending through pin holes of the link plates, and in which the link plates have teeth with inner and outer engagement surfaces shaped so that, at the beginning of engagement with the sprocket, an inner engagement surface begins to engage a sprocket tooth, and after a link plate begins to engage with a sprocket an outer engagement surface of said link plate seats on the sprocket, wherein, in each said link plate, an inner engagement surface that begins to engage a sprocket tooth, the inner surfaces of its pin holes and the outer engagement surfaces that seat on a sprocket tooth are punched by pressing, and each includes a shear surface, said shear surfaces of each plate being formed simultaneously by shaving, after said pressing, and extending over a range of at least 70% of the plate thickness.

2. A silent chain transmission according to claim 1, in which the width w of each plate in a link row, and the height h of each said plate are smaller than the width W and height H of a link, defined as the height and width of envelope of the plates of the same link row link projected in the chain width direction, and the width W and height H are substantially equal to a design width Ws, and design height Hs for proper engagement with said sprocket.

3. A silent chain transmission according to claim 1, in which said inner engagement surface of each link plate has the same shape as the tooth form in a cross section, defined in a hob axis direction, of a hob cutter shaped to form the teeth of the sprocket.

4. A silent chain transmission according to claim 2, in which said inner engagement surface of each link plate has the same shape as the tooth form in a cross section, defined in a hob axis direction, of a hob cutter shaped to form the teeth of the sprocket.

5. A silent chain according to claim 1, in which each said plate includes a curved surface continuous with opposed inner engagement surfaces of the teeth, and said curved surface includes a shear surface formed by punching in a press, and shaved shaving after pressing over a range of at least 70% of the plate thickness.

6. A silent chain according to claim 2, in which each said plate includes a curved surface continuous with opposed inner engagement surfaces of the teeth, and said curved surface includes a shear surface formed by punching in a press, and shaved shaving after pressing over a range of at least 70% of the plate thickness.

7. A silent chain according to claim 3, in which each said plate includes a curved surface continuous with opposed inner engagement surfaces of the teeth, and said curved surface includes a shear surface formed by punching in a press, and shaved shaving after pressing over a range of at least 70% of the plate thickness.

8. A silent chain according to claim 4, in which each said plate includes a curved surface continuous with opposed inner engagement surfaces of the teeth, and said curved surface includes a shear surface formed by punching in a press, and shaved shaving after pressing over a range of at least 70% of the plate thickness.
